(19) United States
(12) Patent Application Publication
(10) Pub. No.: US 2018/0280792 A1
(43) Pub. Date: Oct. 4, 2018

(54) METHODS AND USER DEVICES FOR COMPUTER IMPLEMENTED GAMES

(71) Applicant: KING.COM LIMITED, St. Julians (MT)

(72) Inventor: Klas NORDEN, Stockholm (SE)

(21) Appl. No.: 15/943,784

(22) Filed: Apr. 3, 2018

Related U.S. Application Data
(60) Provisional application No. 62/480,699, filed on Apr. 3, 2017.

(51) Int. Cl. A63F 13/2145; A63F 11/00; A63F 13/69; A63F 13/33

(52) U.S. Cl. CPC A63F 13/2145; A63F 11/0074; A63F 2300/205; A63F 13/33; A63F 2011/0083; A63F 13/69

(57) ABSTRACT

A computer implemented method for managing game objects in a computer implemented game comprises displaying the game objects in two or more two dimensional layers. A user input is received which selects one or more game objects. In response to the user input, it is determined which game objects are to be removed and if any of the game objects to be removed is a game removal object. If so the game objects which are to be removed by the game removal object are determined and removed. An updated arrangement of game objects is then displayed.

### CROSS-REFERENCE TO RELATED APPLICATIONS

This application is based on, and claims priority to, U.S. Provisional Application No. 62/480,699, filed on Apr. 3, 2017, the entire contents of which being fully incorporated hereby by reference.

### FIELD OF THE INVENTION

Embodiments of this application relate to a user device for use in playing a computer implemented game.

Some embodiments may relate to engaging users or players in a computer game executable in an online environment.

The embodiments may have particular, but not exclusive application in the field of computer implemented applications including for example games, in an online or offline environment, and computing devices therefor.

### BACKGROUND OF THE INVENTION

A common genre of casual games is so-called match games. This is a type of tile-matching game where the player manipulates tiles or game objects according to a matching criterion.

A technical challenge exists when introducing complexity into match games particularly when the game is played on relatively small screen such as a smart phone or table. It can be technically challenging to achieve this objectives where a user makes a relatively simple move, leading to the removal of game elements.

Another significant technical challenge is that of user engagement. Engagement involves designing gameplay to be engaging and rewarding to players. Effective engagement requires various forms of feedback to reinforce player sense of success and accomplishment. This is a particular technical challenge in the context of adversarial games between different players.

In particular, there are many technical challenges and technical considerations facing the design of such computer games when considering user engagement. For example, it may be technically challenging to create an engaging game on a small screen, for instance on a mobile device.

The internet is becoming ubiquitous with everyday life, and populations which are smartphone users, are becoming more and more reliant on being able to communicate with other people globally. Furthermore, casual online gaming which gives users the ability to interact with other users from across the globe is becoming more commonplace.

Another significant technical challenge exists with online casual gaming when general knowledge type questions are presented to the users, as people from around the world will have different common general knowledge. This may be especially true when in relation to a user's geographical locality, and popular culture, for example, sports, music, and history. This may also depend on how far apart users are geographically located i.e. the region in which a user resides, for example a user in England, is likely to have similar common general knowledge to a user in Wales, however a user in Japan may have very different common general knowledge. Thus users may find different questions easy or difficult depending on their geographical locality.

This patent specification describes not only various ideas and functions, but also their creative expression. A portion of the disclosure of this patent document therefore contains material to which a claim for copyright is made and notice is hereby given: Copyright King.com Limited 2017 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

According to an aspect there is provided a computer implemented method of managing game objects in a computer implemented game, presented on a display of a computer device having at least one processor, at least one memory and a user interface, the method comprising: displaying, on the display an arrangement of selectable game objects each having one or more characteristics, information on the arrangement of game objects and the one or more characteristics of the game objects being stored in the at least one memory, the displayed arrangement comprising a first two dimensional layer of selectable game objects arranged overlying at least one further two dimensional layer of selectable game objects; determining by the at least one processor, a selection of at least one first game object in dependence on a user input received via the user interface; evaluating by the at least one processor, using the stored information in the at least one memory, responsive to the selection of a least one first game object which one or more of the game objects is to be removed and if any of the game objects which is to be removed is a game removal object comprising a game object removal characteristic; determining by the at least one processor, when at least one game object to be removed comprises a game removal object, at least one second game object to be removed, in at least one direction extending from the game removal object; displaying, on the display an updated arrangement of selectable game objects, the game objects determined to be removed having been removed from the updated arrangement.

The at least one direction may comprise at least one direction in a same layer as the game removal object. In some embodiments, the at least one second game object may only be in the same layer as the game removal object.

The at least one direction may comprise at least one direction which extends from a same layer as the game removal object to at least one different layer. In some embodiments, the at least one second game object may only be in one or more different layers as the game removal object.

In some embodiments, the at least one direction may comprise at least one direction in a same layer as the game removal object and at least one direction which extends from a same layer as the game removal object to at least one different layer.

According to an aspect there is provided a computer device adapted to play a computer game, comprising at least one processor, at least one memory, a display, a user interface and computer code stored in the memory, and in which the computer code generates computer game graphics for display on the display, and in which the at least one processor is configured to execute steps to: cause display, on the display, of an arrangement of selectable game objects each having one or more characteristics, information on the arrangement of game objects and the one or more characteristics of the game objects being stored in the at least one memory, the displayed arrangement comprising a first two dimensional layer of selectable game objects arranged overlying at least one further two dimensional layer of selectable game objects; determine a selection of at least one first game object in dependence on a user input received via the user interface; evaluate, using the stored information in the at least one memory, responsive to the selection of a least one first game object which one or more of the game objects is to be removed and if any of the game objects which is to be removed is a game removal object comprising a game object removal characteristic; determine when at least one game object to be removed comprises a game removal object, at least one second game object to be removed, in at least one direction extending from the game removal object; cause display, on the display of an updated arrangement of selectable game objects, the game objects determined to be removed having been removed from the updated arrangement.

The at least one direction may comprise at least one direction in a same layer as the game removal object. In some embodiments, the at least one second game object may only be in the same layer as the game removal object.

The at least one direction may comprise at least one direction which extends from a same layer as the game removal object to at least one different layer. In some embodiments, the at least one second game object may only be in one or more different layers as the game removal object.

In some embodiments, the at least one direction may comprise at least one direction in a same layer as the game removal object and at least one direction which extends from a same layer as the game removal object to at least one different layer.

A non-transitory computer readable storage device storing instructions that, when executed by at least one processor, causes the at least one processor to perform the following steps: cause display, on a display, of an arrangement of selectable game objects each having one or more characteristics, the displayed arrangement comprising a first two dimensional layer of selectable game objects arranged overlying at least one further two dimensional layer of selectable game objects; determine a selection of at least one first game object in dependence on a user input received via a user interface; evaluate responsive to the selection of a least one first game object which one or more of the game objects is to be removed and if any of the game objects which is to be removed is a game removal object comprising a game object removal characteristic; determine, when at least one game object to be removed comprises a game removal object, at least one second game object to be removed in at least one direction extending from the game removal object; and cause displaying, on the display, of an updated arrangement of selectable game objects, the game objects determined to be removed having been removed from the updated arrangement.

According to an aspect, there is provided a computer device adapted to play a computer game, comprising at least one processor, at least one memory, a display, a user interface and computer code stored in the memory, and in which the computer code generates computer game graphics for display on the display, and in which the at least one processor is configured to execute steps to: cause the display to display an arrangement of selectable game objects each having one or more characteristics, information on the arrangement of game objects and the one or more characteristics of the game objects being stored in the at least one memory; determine, a selection of at least one first game object in dependence on a user input received via the user interface; evaluate, using the stored information in the at least one memory, responsive to the selection of at least one first game object if the selected at least one first game object satisfies a first game criteria; when it is determined that the first game criteria is satisfied, cause the display to display a question; receive an input from the user interface, the input providing an answer to the question; evaluate based on the answer and the selected at least one first game object if one or more game objects are to be removed; and if one or more game objects are to be removed, cause the display, on the display, of an updated arrangement of selectable game objects, the game objects determined to be removed having been removed from the updated arrangement.

The at least one processor may be configured to execute steps to cause the display to display the question along with a plurality of different answer options, and receive an input from the user interface, the input selecting one of the plurality of different answer options to provide the answer.

The at least one processor may be configured to evaluate that the first game criteria has been satisfied when two or more first game objects having a common characteristic have been selected by the user input.

The at least one processor may be configured to evaluate that the first game criteria has been satisfied when the selection of the at least one first game object causes a match condition to be satisfied.

The at least one processor may be configured to cause the display to display in succession a plurality of questions and to evaluate only after the plurality of questions have been answered if the one or more of the game objects are to be removed.

The at least one processor may be configured to cause display of the question such that a type of the question is selected in dependence on at least one characteristic associated with the selected at least one first game object.

The at least one processor may be configured to display the question such that a difficulty of the question is selected in dependence on at least one characteristic associated with the selected at least one first game object.

The at least one processor may be configured to determine a geographic location of the computer device and to display the question such that the question is dependent on the geographic location of the computer.

According to an aspect there is provided a computer implemented method of managing game objects in a computer implemented game, presented on a display of a computer device having at least one processor, at least one memory and a user interface, the method comprising: causing, by the at least one processor, display on the display of an arrangement of selectable game objects each having one or more characteristics, information on the arrangement of game objects and the one or more characteristics of the game objects being stored in the at least one memory; determining, by the at least one processor, a selection of at least one first game object in dependence on a user input received via the user interface; evaluating, by the at least one processor, using the stored information in the at least one memory, responsive to the selection of at least one first game object if the selected at least one first game object satisfies a first game criteria; when it is determined that the first game criteria is satisfied, causing, by the at least one processor, the display to display a question; receiving an input from the user interface, the input providing an answer to the question; evaluating, by the at least one processor, based on the answer and the selected at least one first game object if one or more game objects are to be removed; and if one or more game objects are to be removed, causing by the at least one processor the display, on the display, of an updated arrangement of selectable game objects, the game objects determined to be removed having been removed from the updated arrangement.

The method may comprise causing, by the at least one processor, the display to display the question along with a plurality of different answer options, and receiving an input from the user interface, the input selecting one of the plurality of different answer options to provide the answer.

The method may comprise evaluating, by the at least one processor, that the first game criteria has been satisfied when two or more first game objects having a common characteristic have been selected by the user input.

The method may comprise evaluating, by the at least one processor, that the first game criteria has been satisfied when the selection of the at least one first game object causes a match condition to be satisfied.

The method may comprise causing, by the at least one processor, the display to display in succession a plurality of questions and to evaluate only after the plurality of questions have been answered if the one or more of the game objects are to be removed.

The method may comprise causing, by the at least one processor, the display to display the question such that a type of the question is selected in dependence on at least one characteristic associated with the selected at least one first game object.

The method may comprise causing, by the at least one processor, the display to display the question such that a difficulty of the question is selected in dependence on at least one characteristic associated with the selected at least one first game object.

The method may comprise determining, by the at least one processor, a geographic location of the computer device and to display the question such that the question is dependent on the geographic location of the computer.

A non-transitory computer readable storage device storing instructions that, when executed by at least one processor, causes the at least one processor to perform the following steps: cause display on a display of an arrangement of selectable game objects each having one or more characteristics; determine a selection of at least one first game object in dependence on a user input received via a user interface; evaluate responsive to the selection of at least one first game object if the selected at least one first game object satisfies a first game criteria; when it is determined that the first game criteria is satisfied, cause the display to display a question; receive an input from the user interface, the input providing an answer to the question; evaluate based on the answer and the selected at least one first game object if one or more game objects are to be removed; and if one or more game objects are to be removed, cause display, on the display, of an updated arrangement of selectable game objects, the game objects determined to be removed having been removed from the updated arrangement.

According to an aspect, there is provided a computer device adapted to play a computer game, the computer device comprising at least one processor, at least one memory, a display, a user interface and computer code stored in the memory, and in which the computer code generates computer game graphics for display on the display, and in which the at least one processor is configured to execute steps to: determine a geographic location of the computer; cause the display to display a question, the question being dependent on the geographic location of the computer device; receive an input from the user interface, the input providing an answer; determine if the answer is correct or incorrect; and in dependence on if the answer option is correct or incorrect, cause the display to display answer feedback information.

The at least one processor may be configured to cause the display to display the question along with a plurality of different answer options, and receive an input from the user interface, the input selecting one of the plurality of different answer options to provide the answer.

The computer device may comprise an input configured to receive game play information from another computer device, such that a first user of the computer device and a second user of the another computer device play a same game.

The at least one processor may be configured to cause up to n questions to be displayed on the display for each turn of the first user playing the game.

N may be an integer which is equal to one or more. In some embodiments, n may for example be 2.

The at least one processor may be configured, when the at least one processor has determined that the answer is incorrect, to cause information to be output to the another device allowing the second user to complete a turn of the first user, the computer device comprising an output configured to output the information allowing the second user to attempt to complete the turn of the first user.

The game play information from the another computer device may comprise information allowing the first user to attempt to complete the turn of the second user, and in response, the at least one processor is configured to cause the display of a question, the question being the same as the question in the turn of the second user.

The game play information from the another computer device may comprise information allowing the first user to attempt to complete the turn of the second user, and in response, the at least one processor is configured to cause the display of a question, the question being different to the question in the turn of the second user.

The game play information from the another computer device may comprise information allowing the first user to attempt to complete the turn of the second user, and in response, the at least one processor is configured to cause the display of a question, the question being different to the question in the turn of the second user and being dependent on the location of the computer device.

According to an aspect there is provided a computer implemented method of managing game objects in a computer implemented game, presented on a display of a computer device having at least one processor, at least one memory and a user interface, the method comprising: determining, by the at least one processor, a geographic location of the computer; causing by the at least one processor, the display to display a question, the question being dependent on the geographic location of the computer device; receiving, by the at least one processor, an input from the user interface, the input providing an answer; determining, by the at least one processor, if the answer is correct or incorrect; and in dependence on if the answer option is correct or incorrect, causing, by the at least one processor, the display to display answer feedback information.

The method may comprise causing, by the at least one processor, the display to display the question along with a plurality of different answer options, and receiving an input from the user interface, the input selecting one of the plurality of different answer options to provide the answer.

The method may comprise causing, by the at least one processor, receiving game play information from another computer device via an input, such that a first user of the computer device and a second user of the another computer device play a same game.

The method may comprise causing, by the at least one processor, up to n questions to be displayed on the display for each turn of the first user playing the game.

N may be an integer which is equal to one or more. In some embodiments, n may for example be 2.

The method may comprise causing, by the at least one processor, when it is determined that the answer is incorrect, information to be output to the another device allowing the second user to complete a turn of the first user,

The game play information from the another computer device may comprise information allowing the first user to attempt to complete the turn of the second user, and the method may comprise causing, by the at least one processor, in response to the information the display to display a question, the question being the same as the question in the turn of the second user.

The game play information from the another computer device may comprise information allowing the first user to attempt to complete the turn of the second user, and the method may comprise causing, by the at least one processor, in response to the information the display to display a question, the question being different to the question in the turn of the second user.

The game play information from the another computer device may comprise information allowing the first user to attempt to complete the turn of the second user, and the method may comprise causing, by the at least one processor, in response to the information the display to display a question, the question being different to the question in the turn of the second user and being dependent on the location of the computer device.

A non-transitory computer readable storage device storing instructions that, when executed by at least one processor, causes the at least one processor to perform the following steps: determine a geographic location of the computer; cause the display to display a question, the question being dependent on the geographic location of the computer device; receive an input from the user interface, the input providing an answer; determining, by the at least one processor, if the answer is correct or incorrect; and in dependence on if the answer option is correct or incorrect, cause the display to display answer feedback information.

According to an aspect there is provided a computer device adapted to play a computer game, comprising at least one processor, at least one memory, a display, a user interface and computer code stored in the memory, and in which the computer code generates computer game graphics for display on the display, and in which the at least one processor is configured to execute steps to: cause display, on the display, of an arrangement of selectable game objects each having at least a first characteristic, the first characteristic having a plurality of different options, information on the arrangement of game objects and for each of the selectable game object, an associated option for the first characteristic being stored in the at least one memory; determine a selection of at least one first game object in dependence on a user input received via the user interface; evaluate, using the stored information in the at least one memory, responsive to the selection of a least one first game object if a first game criteria has been satisfied and in respect of which associated option of the first characteristic; and determine if a second game criteria has been satisfied, the second game criteria depending on the first game criteria.

If the second game criteria is satisfied, the at least on processor is configured to determine that the game has been won.

The second criteria may depend on the first game criteria being satisfied for a plurality of different options of the first characteristic.

The second game criteria may depend on the first game criteria being satisfied for all of the plurality of different options of the first characteristic.

The selectable game objects are each configured to have a second game characteristic, in addition to the first game characteristic, the second game characteristic each have one of a plurality of different options.

The second game characteristic provide points, with different options providing different points.

The computer device may comprise an input configured to receive game play information from another computer device, such that a first user of the computer device and a second user of the another computer device play a same game.

The second criteria may be satisfied if a number of the first criteria satisfied for different options in the computer device is greater than a number of the first criteria satisfied for different options in the game in the another computer device.

The at least one processor may be configured to evaluate, if the first game criteria has been satisfied for a given option of the first characteristic further taking into account game play information from the another computer device indicating that the first game criteria for the given option has been satisfied by game play in the another device.

The at least one processor may be configured to compare the associated points provided by the second game characteristic for the given option of the first characteristic with information received from the another device about the associated points provided by the second game characteristic for the same given option of the first characteristic to evaluate if the first game criteria has been satisfied.

According to an aspect there is provided a computer implemented method of managing game objects in a computer implemented game, presented on a display of a computer device having at least one processor, at least one memory and a user interface, the method comprising: cause display, on the display, of an arrangement of selectable game objects each having at least a first characteristic, the first characteristic having a plurality of different options, information on the arrangement of game objects and for each of the selectable game object, an associated option for the first characteristic being stored in the at least one memory; determine a selection of at least one first game object in dependence on a user input received via the user interface; evaluate, using the stored information in the at least one memory, responsive to the selection of a least one first game object if a first game criteria has been satisfied and in respect of which associated option of the first characteristic; and determine if a second game criteria has been satisfied, the second game criteria depending on the first game criteria.

If the second game criteria is satisfied, the method may comprise causing, by the at least one processor that the game has been won.

The second criteria may depend on the first game criteria being satisfied for a plurality of different options of the first characteristic.

The second game criteria may comprise determining that the first game criteria has been satisfied for all of the plurality of different options of the first characteristic.

The selectable game objects are each configured to have a second game characteristic, in addition to the first game characteristic, the second game characteristic each have one of a plurality of different options.

The second game characteristic provide points, with different options providing different points.

The method may comprise receiving at the at least one processor, game play information from another computer device, such that a first user of the computer device and a second user of the another computer device play a same game.

The method may comprise determining, by the at least one processor that the second criteria is satisfied if a number of the first criteria satisfied for different options in the computer device is greater than a number of the first criteria satisfied for different options in the game in the another computer device.

The method may comprise evaluating by the at least one processor, if the first game criteria has been satisfied for a given option of the first characteristic further taking into account game play information from the another computer device indicating that the first game criteria for the given option has been satisfied by game play in the another device.

The method may comprise by the at least one processor, comparing the associated points provided by the second game characteristic for the given option of the first characteristic with information received from the another device about the associated points provided by the second game characteristic for the same given option of the first characteristic to evaluate if the first game criteria has been satisfied.

A non-transitory computer readable storage device storing instructions that, when executed by at least one processor, causes the at least one processor to perform the following steps: cause display, on a display, of an arrangement of selectable game objects each having at least a first characteristic, the first characteristic having a plurality of different options; determine a selection of at least one first game object in dependence on a user input received via a user interface; evaluate responsive to the selection of a least one first game object if a first game criteria has been satisfied and in respect of which associated option of the first characteristic; and determine if a second game criteria has been satisfied, the second game criteria depending on the first game criteria.

According to an aspect there is provided a computer device comprising: an input configured to receive information from a plurality of different computer devices, the information indicating for a plurality of different questions if the question has been answered correctly in the respective computer device, at least one processor configured to determine based on the received information and location information associated with respective computer device, for each question a difficulty rating associated with a respective geographic location; and an output configured to output to the plurality of computer devices difficulty information for at least a plurality of questions, the difficulty information being dependent on the respective location of the respective computer device.

According to an aspect there is provided a computer device comprising: an input configured to receive information from a plurality of different computer devices, the information indicating for a plurality of different questions if the respective question has been answered correctly in the respective computer device, at least one processor configured to determine based on the received information, for each question a difficulty rating; and an output configured to output to the plurality of computer devices the difficulty information for the plurality of questions, wherein the input is configured to receive further information for the plurality of different questions if the question has been answered correctly, the at least one processor configured to update the difficulty rating using the further information and the output is configured to output the updated difficulty information.

According to an aspect there is provided a computer implemented method in a computer device having at least one processor, at least one memory and an interface, the method comprising: receiving information via the interface from a plurality of different computer devices, the information indicating for a plurality of different questions if the question has been answered correctly in the respective computer device, determining, by the at least one processor based on the received information and geographic location information associated with respective computer device, for each question a difficulty rating associated with a respective geographic location; and outputting via the interface to the plurality of computer devices difficulty information for at least a plurality of questions, the difficulty information being dependent on the respective location of the respective computer device.

According to an aspect there is provided a computer implemented method in a computer device having at least one processor, at least one memory and an interface, the method comprising: receiving information via the interface from a plurality of different computer devices, the information indicating for a plurality of different questions if the question has been answered correctly in the respective computer device; determining, by the at least one processor based on the received information, for each question a difficulty rating; and outputting via the interface to the plurality of computer devices the difficulty information for the plurality of questions, wherein the method further comprises receiving further information for the plurality of different questions if the question has been answered correctly, updating by the at least one processor the difficulty rating using the further information and outputting via the interface the updated difficulty information.

A non-transitory computer readable storage device storing instructions that, when executed by at least one processor, causes the at least one processor to perform the following steps: receive information from a plurality of different computer devices, the information indicating for a plurality of different questions if the question has been answered correctly in the respective computer device, determine based on the received information and geographic location information associated with respective computer device, for each question a difficulty rating associated with a respective geographic location; and output to the plurality of computer devices difficulty information for at least a plurality of questions, the difficulty information being dependent on the respective location of the respective computer device.

A non-transitory computer readable storage device storing instructions that, when executed by at least one processor, causes the at least one processor to perform the following steps: receive information from a plurality of different computer devices, the information indicating for a plurality of different questions if the question has been answered correctly in the respective computer device; determine, by the at least one processor based on the received information, for each question a difficulty rating; output to the plurality of computer devices the difficulty information for the plurality of questions; receive further information for the plurality of different questions if the question has been answered correctly; update by the at least one processor the difficulty rating using the further information; and output via the interface the updated difficulty information.

### BRIEF DESCRIPTION OF DRAWINGS

To understand some embodiments, reference will now be made by way of example only to the accompanying drawings, in which:

FIG. 1 shows an example computing device of an embodiment;

FIG. 2 illustrates an example system in which some embodiments may be provided;

FIG. 3 shows a back-end system according to some embodiments;

FIG. 4 shows an example of a first game board;

FIG. 5 shows an example computer implemented method of matching game elements of the first type;

FIGS. 6A-6C show three examples game boards;

FIG. 7 shows a further example of a game board;

FIG. 8 shows an example of user segmentation;

FIG. 9A shows an example of a computer implemented method where one player gains or steals points from an opponent;

FIG. 9B shows schematically graphical representations of the scoring:

FIG. 10 is a schematic diagram of a game board of a match three game illustrating an example of a match three game; and

FIG. 11 is a schematic diagram illustrating how a game board such as shown in FIG. 10 is populated with replacement game elements; and

FIG. 12 shows another method.

### DETAILED DESCRIPTION OF SOME EMBODIMENTS

The terms user and player are used interchangeably throughout this document and no specific meaning is intended using one or the other unless the context suggests otherwise.

In the following description of various implementations of the invention, reference is made to the accompanying drawings which form a part thereof, and in which is shown by way of illustration various implementations in which the invention may be utilized. It is to be understood that other implementations may be utilized, and structural and functional modifications may be made without departing from the scope of the present invention.

A person skilled in the art will realise that the different approaches to implementing the game is not exhaustive, what is described herein are certain preferred embodiments. It is possible to implement the way in a number of variations.

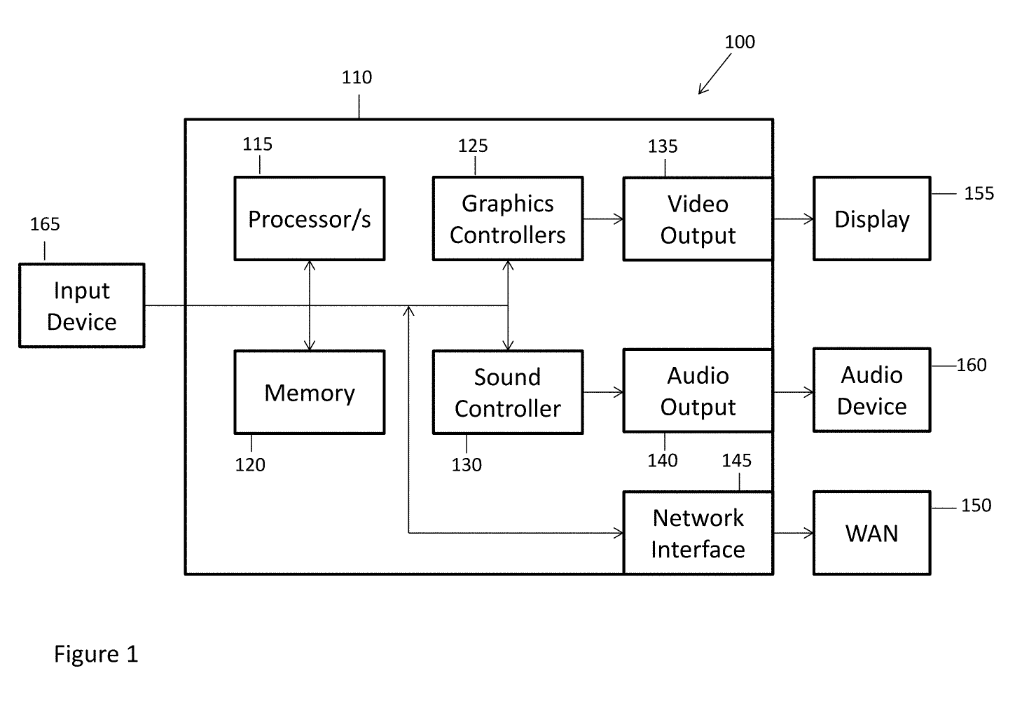

A schematic view of a user device 100 according to an embodiment is shown in FIG. 1. All of the blocks shown are implemented by suitable circuitry. The blocks may be implemented in hardware and/or software. The user device may have a control part 110. The control part 110 has one or more processors 115 and one or more memories 120. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The controller 110 has an interface 145 allowing the device to be able to communicate with a network 150 such as the Internet or other communication infrastructure.

The video output 135 is provided to a display 155. The audio output 140 is provided to an audio device 160 such as a speaker and/or earphone(s).

The device 100 has an input device 165. The input device 165 can take any suitable format and can be one or more of a keyboard, mouse, touch screen, joystick or game controller. It should be appreciated that the display 155 may in some embodiments also provide the input device 165 by way of an integrated touch screen for example.

The blocks of the controller 110 are configured to communicate with each other by an interconnect such as a bus or any other suitable interconnect and/or by point to point communication.

It should be appreciated that in some embodiments, the controller 110 may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

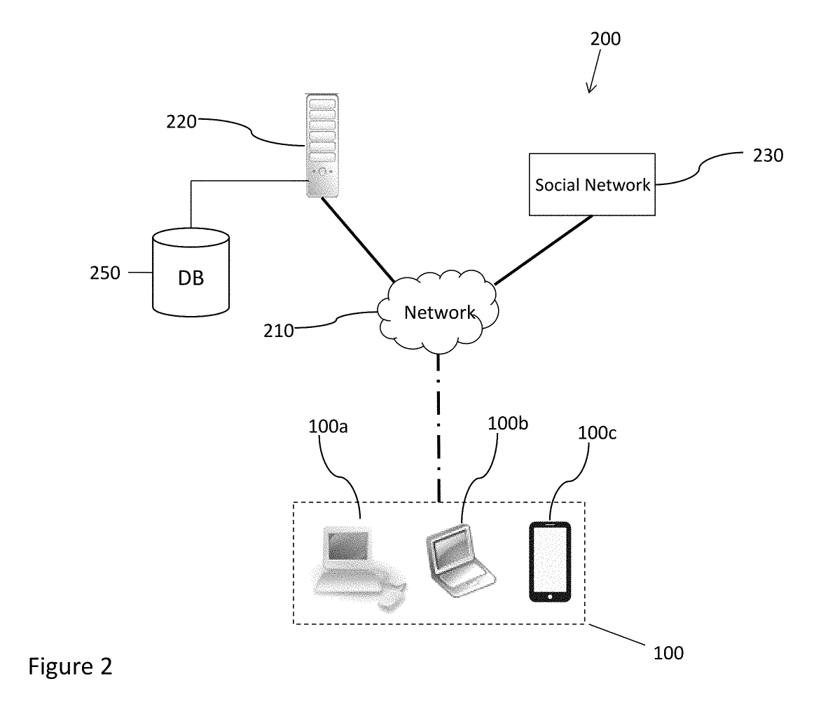

FIG. 2 schematically shows a system 200 in some embodiments. The system 200 comprises a server 220 which may store or be in communication with databases 250 of game player's details, profiles, statistics, etc. In practice, one or more databases 250 may be provided. Where more than one server 220 is provided, the database(s) 250 may be provided in one database 250 or in data bases across two or more servers 220, 310. The server 220 may also have a games data function. This may comprise one or more units of memory to store the computer game program and user behaviour data, and a processor to run the games program and process the user behaviour data.

The server 220 may communicate via for instance the internet 210 to one or more user devices 100, shown in the figure by way of example as user devices 100a, 100b and 100c, and may further provide connections to a social network 230.

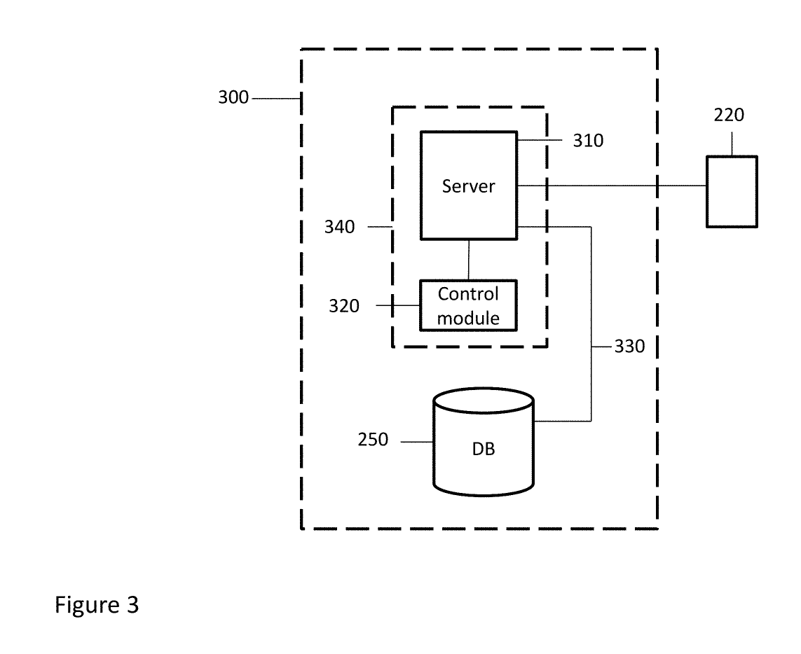

FIG. 3 illustrates a back end infrastructure 300 according to an embodiment, comprising a server 310 in communication with or connected to a control module 320. The control module 320 may be implemented 340 as part of server 310, or may be a separate module 320 external to and connected with the server 310. The server 310 may be one of many servers, such as those known to the person skilled in the art as a server farm 340, or rack.

The server 310 or server farm 340 may be connected as shown to server 220, and to database 250 via link 330. Link 330 may be wired, wireless and/or provided via or through networks such as the internet, as known to those persons skilled in the art. The control module 320 provides control and update of data in the database(s) 250.

### Trivia Questions

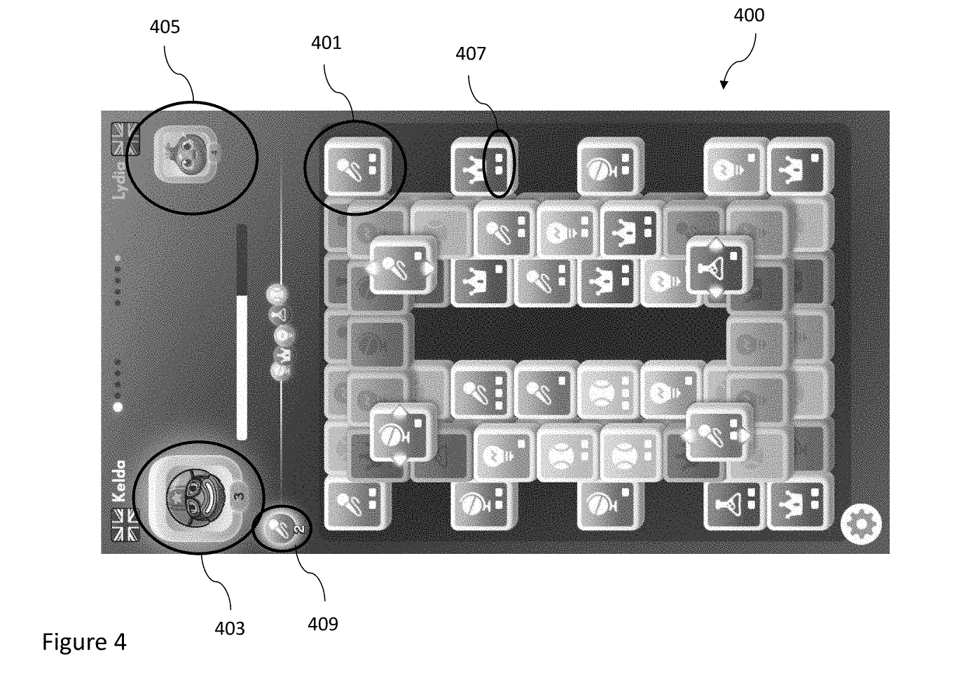

Reference is now made to FIG. 4 which shows an example of a first game board 400 which is displayed on a display 155. The first game board comprises a number of game elements of a first type 401, which may be for example, game tiles. The game elements of a first type may be arranged in a two dimensional grid structure, or a similar pattern. It should be appreciated that many arrangements may be used such that the game elements of the first type may be arranged in a number of different patterns.

Some embodiments facilitate a competitive game between two or more users. The competitive game may be turn based, wherein a user must match one or more game characteristics of two or more game elements of a first type (game tiles) on a game board. The matching may be a simple match where a user is required to select two or more tiles having the same characteristic. In other embodiments, the matching may require the user to select two or more tiles having a predefined spatial relationship. In other embodiments, the user may be required to manipulate one or more tiles in order to achieve a desired match. For example, the user may move, slide or switch one tile to achieve a match of two or more adjacent tiles to obtain a predefined spatial relationship. For example, the user may move, slide or switch a tile to achieve a match 3 or more condition. In other embodiments, the matching may require the user to select two or more tiles using any suitable rule or rules.

On correctly matching one or more game characteristics of two or more game tiles, a user may be presented with one or more general knowledge questions that need to be answered. When the one or more questions are correctly answered, the processor may cause the removal of the previously selected one or more game tiles. From the matching of one or more game characteristics of two or more game tiles, to the removal of game tiles from the game board may constitute a user's turn. If a user answers the one or more questions incorrectly, on inputting an incorrect answer, may constitute the end of a user's turn. When a user's turn has ended, it is the turn of the other user. A user may be provided with more than one turn in succession depending on one or more game characteristics, for example, as a reward for answering one or more difficult questions correctly, and/or for example, where a user has met another criteria.

The other user (opponent) may be another user using a different or the same device, for example, mobile phone. Alternatively or additionally, the other user, may be provided by artificial intelligence AI provided by the processor, and/or externally by a server.

The game may also be played by a single player, wherein at the end of a user's turn, it is not the turn of an opponent, but the same user may begin a new turn by matching game elements of the first type (game tiles).

The game elements of a first type may each have one of a plurality of different game characteristics. In this example, the different game characteristics are represented by an image of: a microphone and pink; a crown and red; a baseball and yellow; a globe and blue; a lightbulb and green; and a conical flask and purple.

A user may select a first game element of a first type and then a second game element of a first type, wherein when the second game element of the first type shares the same game characteristics with the first game element of the first type, the system may display one or more questions to the user. If the user answers the one or more questions correctly, the first and second game elements of the first type selected are removed from the game board. The questions presented to the user may be based on a predefined category associated with the game characteristics of the game elements of the first type. For example, a game characteristic of a microphone may be associated with a question category of music. A game characteristic of a crown may be associated with a question category of history. A game characteristic of a baseball may be associated with a question category of sport. A game characteristic of a globe may be associated with a question category of geography. A game characteristic of a lightbulb may be associated with a question category of general knowledge. A game characteristic of a conical flask may be associated with a question category of science. It should be appreciated that they types of question category provided is by way of example only and different question categories may alternatively or additionally be provided.

The game elements of the first type may further be arranged into one or more layers (i.e. the game elements of a first type may be arranged into a three dimensional array having a depth of any integer value, for example, 2 or 3). If a first game element of the first type in a first layer is placed on top of a second game element of the first type in a second layer below, the second game element of the first type in the second layer, may not be selectable until the first game element of the first type in the first layer has been removed. If a first game element of the first type in a second layer is placed on top of a second game element of the first type in a third layer below, the second game element of the first type in the third layer, may not be selectable until the first game element of the first type in the second layer has been removed and so forth.

Furthermore, it may be possible to select only certain game elements of the first type. For example, it may only be possible to select game elements which are highlighted, for example, with a white border, and not be possible to select game elements of the first type, which are darker, and do not have a white border. It may be possible to activate a game element, which is not previously selectable, by removing an adjacent or neighbouring game element.

The game elements of the first type may further comprise an indicator of difficulty 407, for example, one star for easy questions, two stars for average questions, and three stars for difficult questions. The number of levels may be more or less than three in other embodiments.

An avatar 403 of a first user may be displayed on the game board 400, and an avatar of the user's opponent (second user) 405 may also be displayed on the game board 400. The user's score 409 may also be displayed on the game board 400. The geographical location associated with the location of a player may be indicated adjacent the avatar of the respective player. This may for example be represented by an appropriate flag.

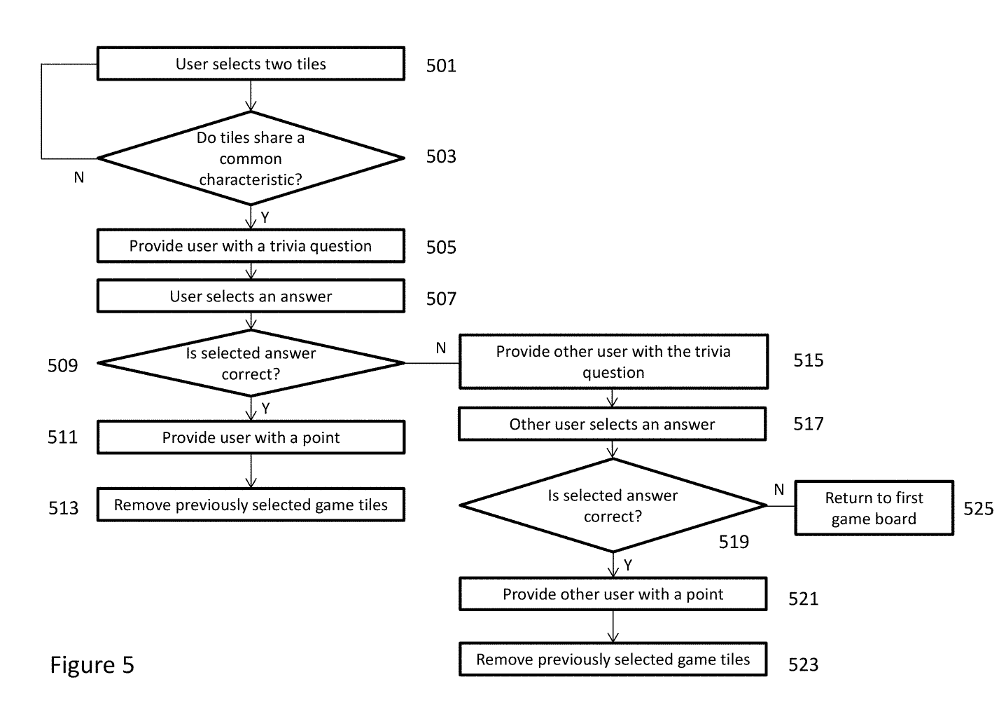

Reference is now made to FIG. 5 which shows an example method of matching game elements of the first type.

In step 501, a user selects two first game elements 401 of a first type using an input device 165, which may be game tiles, from the first game board 400 which is displayed onto a display 155. The user may have to select two first game elements of the first type within a pre-defined time limit which may be determined by a processor 115 or by an external server, the determination may alternatively or additionally be made at a server. It should be appreciated that the selection of two first game elements 401 of a first type, is by way of example only, the application may be so designed to respond to a matching of two or more game elements of a first type.

In step 503, a comparison is made between the at least two selected game elements of the first type at a processor 115 or at an external server, the comparison may alternatively or additionally be made at a server, and a determination on whether the game elements of the first type share at least one common game characteristic is made, the determination may be made at a processor 115, the determination may alternatively or additionally be made at a server, for example, where both game elements of the first type are game tiles, a determination is made as to whether both tiles share at least one common game characteristic, for example, as to whether both game tiles have an image of a microphone and are pink. The at least one common game characteristic may be compared against known game characteristics, stored in a memory 120 of the device, or stored externally on a server.

In step 505, where it has been determined that the game elements of the first type share at least one common game characteristic, the user may be presented with one or more trivia questions on the display 155, and for each question the user may be presented with a list of possible answers. The questions may be generated in advance, and stored in the memory of the device 120, or externally on a server, furthermore, the questions may be generated from the internet. The subject of the one or more trivia questions may depend on the game characteristic, for example, where two images of a microphone are selected question pertaining to music may be provided to the user. The difficulty of the one or more trivia questions indicated difficulty, e.g. by the star rating.

The difficulty of the one or more trivia questions may further depend upon the user's ability, wherein the user's ability may be stored in the memory of the device 120, or externally on a server. The type of the one or more questions may also depend on the user's geographical location, for example, where the user is currently located, and/or the region that the user is from, for example, where the user's home network is registered. The user's geographical location may be stored in the memory of the device 120, or externally on a server. The user's location may also be determined by the user's device, for example, by locating the nearest external server, or using a user's device itself, which may have geographical location apparatus, for example a mobile telephone that has global positioning apparatus e.g. GPS.

In step 507, the user selects one of several possible answers using the input device 165. The user may have to select an answer within a pre-defined time limit, which may be stored in the memory of the device 120, or stored externally on a server.

In step 509, a determination is made by the processor 115, or by an external server, as to whether the selected answer is correct. The determination may be based on answers stored in the memory of the device 120, or externally on a server. If the selected answer is correct, the user may be presented with one or more subsequent questions on the display 155.

In step 511, if the selected answer is determined to be correct by the processor 115 or external server, the user may be awarded with one or more points. As will be described later, the points may depend on the rating of the associated game element, wherein the rating may be stored in the memory of the device 120 or externally on a server.

In step 513, the two selected game elements 401 of the first type, from step 501 are removed from the game board 400.

In step 509, if the user selects an incorrect answer to the one or more questions using the input device 165, one or more questions may be presented to the user's opponent on the opponent's display, or on the user's display 155, step 515. The one or more questions presented to the user's opponent may be the same questions, or one or more may be a different question. The questions presented to the user may be stored in the memory 120 of the user's device, the memory of the opponent's device, or externally on a server. The one or more different questions may depend on the other user's geographical location, for example, where the other user is currently located, and/or the region that the other user is from, for example, where the other user's home network is registered. The opponent's geographical location may be stored in the memory 120 of the user's device, the memory of the opponent's device, or externally on a server. The opponent's location may also be determined by the opponent's device, for example, by locating the nearest external server, or using the opponent's device itself, which may have geographical location apparatus, for example a mobile telephone that has global positioning apparatus e.g. GPS.

In step 517, the opponent selects one of the remaining answers using the input device of the opponent's device, or using the user's input device 165.

In step 519, a determination is made as to whether the answer selected by the opponent is correct at the processor of the opponent's device, the processor of the user's device, or externally on a server. If the selected answer is correct, the opponent may be presented with one or more subsequent questions. The one or more subsequent questions may be stored in the memory of the opponent's device, the memory of the user's device 120, or externally on a server.

In step 521, if it is determined that the selected answer is correct the opponent may be awarded with one or more points, which may be displayed on the display of the opponent's device, or displayed on the display 155 of the user's device. Again, the points may depend on the associated rating, wherein the associated rating may be stored in a memory of the opponent's device, the memory of the user's device, or externally on a server.

In step 523, the two selected game elements 401 of the first type, from step 501 are removed from the game board 400 which may be displayed on the display of the opponent's, and/or the display of the user's device.

If, in step 519, the opponent selects an incorrect answer using the input device, the display of the opponent's, and/or the display of the user's device display the game board 400, step 525. It may be that the game elements that were selected are not removed from the game board.

It should be appreciated that the number of points awarded to each player may be dependent upon one or more game characteristics wherein the number of points for the one or more game characteristics may be stored in a memory 120 of a user's device, and/or opponent's device, and/or externally on a server, for example a difficulty grading of a question, wherein the grading may be any number, for example, any integer number. For example, one point may be awarded for an easy question, two points for an averagely difficult question, and three points, for a hard question. Furthermore, the number of points may be dependent on an aggregation of one or more game characteristics, for example for a star rating of the one or more matched game elements of the first type. For example, where a user has matched a two star rating game tile, and a three star rating tile, on correctly answering the one or more questions, a user may be awarded with five points.

It should be appreciated that the processor and/or a server may perform any of the processing functions. Where a server performs processing functions, the server may receive information form a device where the application is being executed. The server may then perform one or more operations in dependence on the information, and/or perform any querying of data stored in one or more databases. The server may then provide an output based on the one or more operations, which may then be transmitted back to the user device which is executing the application. Additionally or alternatively, the application may be executed on a server, wherein a user inputs instructions to the server via a user device, for example, a mobile telephone.

For example, each time a user makes a move, information is sent to the server. In response, the server provides information about a question to be asked. The user's response is sent back to the server and so on. In addition the server will be also receiving information from the device of the other user. Information about the two user's performance is used by the server to update the score information which is provided to both user devices.

It should be appreciated that in other embodiments, more or less of the game function may be controlled by the server.

In some embodiments, the server may act as a go between for the games on each of the user devices to allow game data to be exchanged between. The games may be controlled by a common seed.

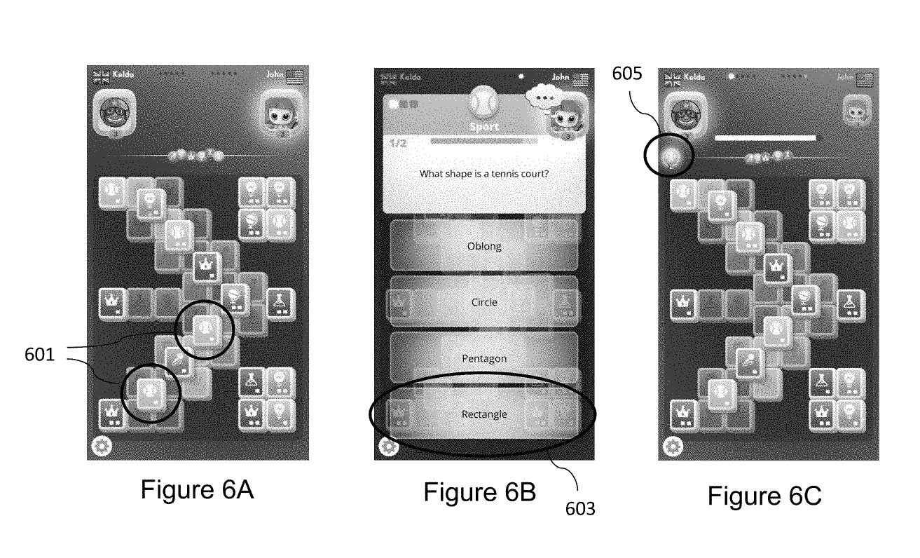

Reference is now made to FIGS. 6A-6C, which show three example game boards.

FIG. 6A, shows an example of an initial game board 400, from which a user can select at least two matching game elements 601 of the first type, for example, two game elements of the first type which share the game characteristics of having an image of a baseball and being yellow in colour.

FIG. 6B, shows an example of a trivia question. In FIG. 6B, the trivia question is based on sport, as the user selected the game elements of the first type which have a game characteristic of a baseball. The user then selects a one of the answers presented to the user. It is then determined whether the answer to the game was correct.

In FIG. 6C, it may be determined by the processor 115 that the user has selected the correct answer, and the user may be awarded with a point indicated by a game element of a second type 605. The game elements of the second type may share one or more game characteristics of the game elements of the first type, for example, a symbol of a baseball.

### Removing Game Tiles

The game application may provide alternative means for users to remove game elements of the first type (game tiles), from the game board 400 displayed on the display 155, other than by correctly matching two tiles and correctly answering one or more questions. For example, the game application may provide users with the ability to remove game tiles by merely matching one or more game characteristics of two or more game tiles, wherein a processor 115, and/or an external server may determine a match. For example, matching two or more game tiles of the same colour, and/or having the same star rating, and/or having the same symbol (e.g. a baseball).

The application may provide hidden objectives to the users, whereby the completion of such hidden objectives, may provide that any one or more selected game tiles may be removed.

### Dynamic Question Difficulty

The difficulty of the trivia questions may be based on an indicator of difficulty 407, for example, a star rating or similar. The difficulty may have three levels, for example, one star for an easy question, two stars for an averagely difficult question, and three stars for a difficult question.

The difficulty of the questions may also be based upon a user's ability, for example, users may be grouped into categories depending on how often they answer a question correctly and/or incorrectly. Furthermore, the users may be ranked on how often they answer a question correctly and/or incorrectly.

The difficulty rating of the questions may be dynamically changed by the processor 115, and/or externally by a server. For example, using data analytics, or a similar method, it may be discovered that a question which is thought to be easy is in fact often answered incorrectly by users. Thus, the difficulty rating of the question may be dynamically changed by the system. There may be pre-defined thresholds for each difficulty rating, defined by a certain percentage of users answering questions correctly. For example, if 90% of users answer a question correctly, then the question may be assigned a difficulty of easy (i.e. one star), when 50% of users are answering a question correctly, then the question may be assigned a difficulty of average difficulty (i.e. two stars), when only 10% of users answer a question correctly, then the question may be assigned a difficulty of hard (i.e. three stars).

The system may continuously or intermittently assess the difficulty of questions based on user responses. The frequency of checks may be pre-defined, for example, once each hour, or once every few hours, and may for example be stored in a memory 120 and/or by an external database. Alternatively or additionally the frequency of assessments may be dynamic, for example, the percentage of correct answers may be assessed when there is high user traffic (i.e. above a pre-defined threshold of users).

In other embodiments, each time a question is answered, count information is updated. Additionally, a further count value us updated if the question is answered correctly/incorrectly.

Alternatively, each time a question is answered, one of an incorrect counter and a correct counter is incremented, depending on if the question was answered incorrectly or correctly.

### Stealing Categories

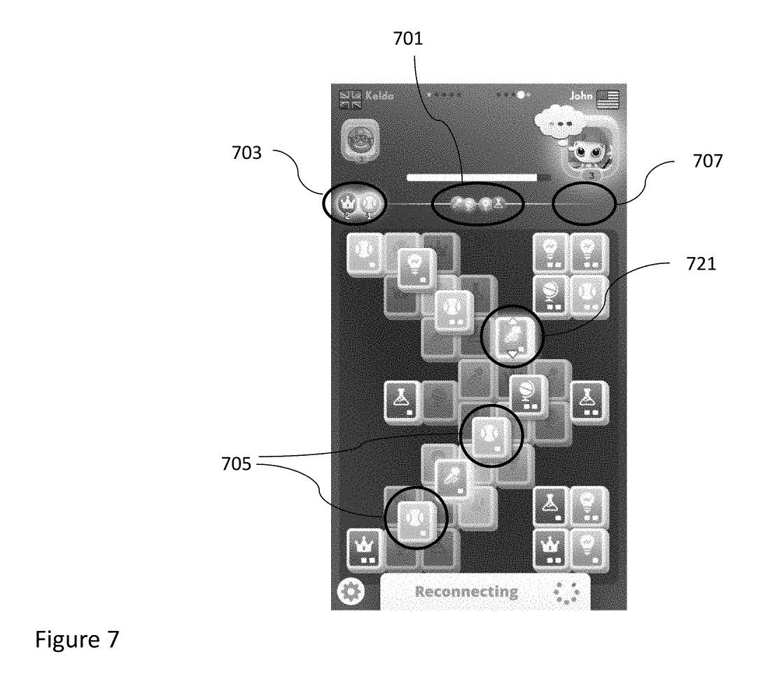

Reference is now made to FIG. 7, which shows another example of a game board. Game elements of a second type associated with each question category referred to in FIG. 4, start in the middle of a slider bar 701. When it is determined by a processor 115 and/or external server that a user has correctly answered one or more questions from a pre-defined category of question, the user may be awarded with a point for that category, and a game element of the second type associated with that category moves to the side of the slider bar closest to the avatar of that user 703. The game elements of the second type may for example, be a symbol of a crown for a history question, and/or a symbol of a baseball for a sports question. There may be a respective game element of the second type associated with each different type of first game element.

The points each user is awarded when correctly answering questions in each category may be stolen by the opposing user. For example, once the first user has been awarded game elements of a second type, for example, of a crown and baseball 703, the opponent may be able to steal those game elements of the second type from the first user by selecting game elements 705 of a first type, corresponding to the category type of the game elements of the second type which have been awarded to the first user. For example, the opponent could steal one of the game elements 703 of the second type, for example the baseball, by correctly matching two game elements 705 of a first type on the game board 400, and correctly answering a trivia question presented to the opponent (other user). If the opponent correctly answers the question, then the game element of the second type 703 of the baseball may move to a position on the slider closest to the avatar of the opponent 707.

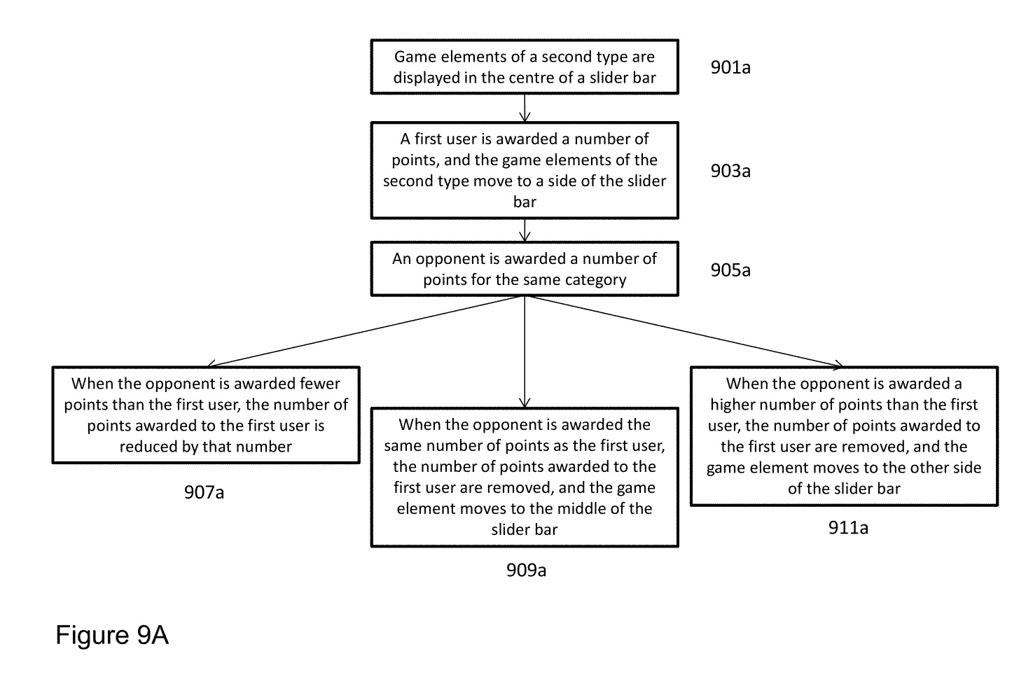

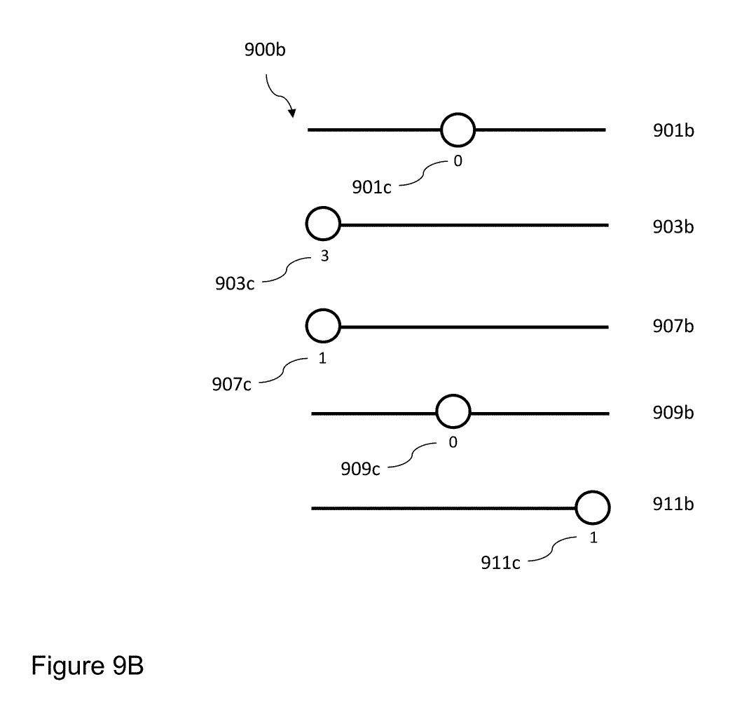

Reference is now made to FIGS. 9A-9B, which show an example of a user's opponent stealing game points. In step 901a, the game elements of a second type are displayed in the centre of bar 900b, 901b, each game element of the second type may represent a question category and may be assigned 0 points 901c.

In step 903a, a first user is awarded a number of points, which may be for a given category, for example, 3 points 903c. The game elements of the second type which may be associated with the category move to one side of the slider bar 903b.

In step 905a, an opponent is awarded a number of points which may be for the same category.

In step 907a, the opponent is awarded with fewer points than the first user has obtained. As such the number of points that were awarded to the first user may be reduced by the number of points awarded to the opponent. The calculation may be performed at a processor 115, and/or externally on a server. For example, if the first user has obtained 3 points, and the opponent is awarded with 2 points in step 907a, the number of points of the first user associated with that game element may be reduced to the value of 1907c. In this scenario, the game element of the second type may not change its location.

In step 909a, the opponent is awarded with the same number of points as the first user has obtained. As such the number of points that were awarded to the first user may be reduced to 0, and the game element of the second type may return to the central position on the slider bar 909b. The calculation may be performed at a processor 115, and/or externally on a server. For example, if the first user has obtained 3 points, and the opponent is awarded with 3 points in step 907a, the number of points of the first user may be reduced to the value of 0, and the number of points associated with that game element may be set to 0 909c.

In step 911a, the opponent is awarded with a higher number of points than the first user has obtained. As such the number of points that were awarded to the first user may be reduced to 0, and the game element of the second type may move to the other end of the slider bar 911b, 707. The calculation may be performed at a processor 115, and/or externally on a server. For example, if the first user has obtained 3 points, and the opponent is awarded with 4 points in step 907a, the number of points of the first user may be reduced to the value of 0, and the opponent may be awarded with the reaming sum of points, i.e. in this example 1 point 911c.

It should be appreciated that a different amount of points may be awarded to each user depending on the game mechanic. The numbers of points may be determined dynamically by a processor 115, and/or externally by a server. The number of points to be awarded may also be stored in a memory 120, and/or externally in a database.

One game objective is to obtain more categories than an opponent.

An alternatively or additional objective of the game may be to remove the game board of one or more game elements of a first type (game tiles) by the removal of game tiles through the completion of a task, for example, answering questions correctly.

An alternatively or additional objective of the game may be to attain more points than an opponent.

Additionally or alternatively the objective may be to remove all the game objects of a first type (game tiles) having one or more game characteristics. For example, removing all the game tiles which are green.

Additionally or alternatively the objective may be to get the highest number of points, for example, by answering the most number of questions and/or by clearing the highest number of tiles.

Achieving a game objective may allow the game to be won or completed.

### Line Blaster

Some game elements of a first type (game tiles) may have a further game characteristic. This further game characteristic 721 may provide the removal of other game elements of the first type from the game board 400, which may be located along the same x and/or y direction on the game board grid structure. This game characteristic may be called a line blaster. This game characteristic of the game elements of the first type may be presented to the user with vertically and/or horizontally directed arrows. This further game characteristic may be stored in a memory 120, and/or externally in a database.

For example, when a user correctly matches game elements of a first type (game tiles) 721, wherein one of the game elements of the first type selected has the game characteristic of a line blaster, if it is determined by a processor 115 and/or externally by a server that the user has correctly answered the one or more questions presented to the user, all the game elements of the first type may be removed in the x and/or y direction of the grid structure surrounding the game elements of the first type which had the game characteristic of the line blaster. The direction may further be diagonal (i.e. having both an x, and y component).

If the game elements of the first type are arranged into a three dimensional array, all the game elements of the first type may be removed in the x and/or y direction of the layer of the grid structure having the x and/or y line blaster. In this case, the game elements which are removed would only be in the same layer as the game element with the further characteristic.

In some embodiments, the game elements may be removed in the z direction (i.e. the direction perpendicular to the plane of the two dimensional array). The direction may further be diagonal (i.e. having both an x, y, and z component). This would mean that game elements in different layers may be removed.

In some embodiments, a line blaster may be associated with a single direction. In some embodiments, the line blaster may be associated with two or more directions. In some embodiments, a line blaster may only have effect in one layer of a three dimensional array with a plurality of layers. In some embodiments, a line blaster may have effect in a plurality of layers of a three dimensional array.

In one alternative embodiment, any game tiles proximate to the game tiles which have the characteristic of the line blaster may be removed, this may also be decided on a radial count. For example, a count of one where all tiles touching the game tile with the line blaster characteristic may be removed. For example, with a radial count of two, would remove all first game tiles touching the game tile with the line blaster characteristic, and further, all second game tiles touching the first game tiles. It should be appreciated that this may be in any direction, for example, an x direction, y direction, or z direction or any combination thereof. For example, tiles may be removed in a three-dimensional sphere surrounding those with the line blaster characteristic.

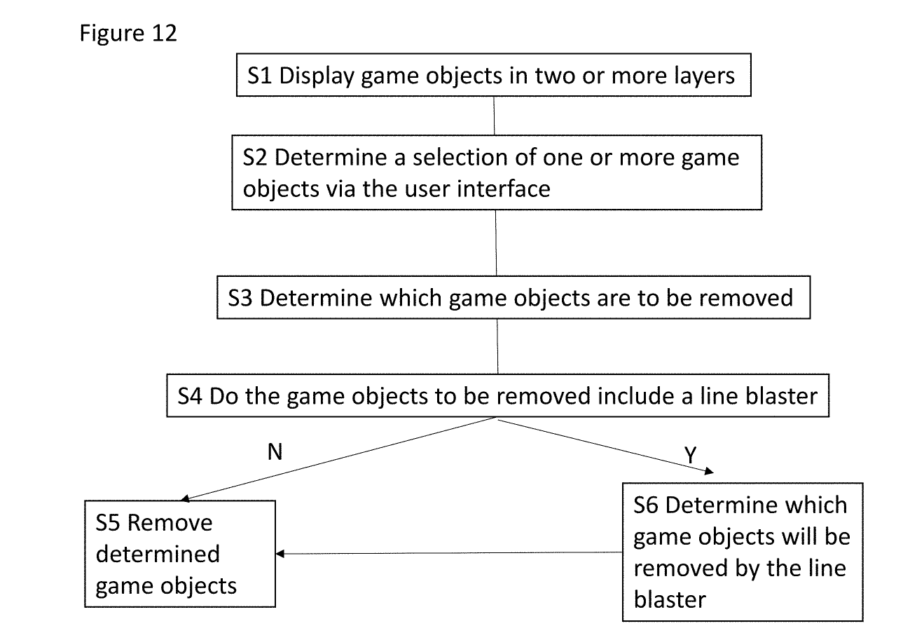

Reference is made to FIG. 12 which shows a method of some embodiments.

In step S1, the game objects are displayed on the display in two or more 2 dimensional layers.

In step S2, the at least one processor determines, a selection of at least one game object by the user, via the user interface.

In step S3, it is determined which game objects are to be removed. This may be for example because a match condition such as described elsewhere in this document has been satisfied.

In step S4, it is determined if any of the game objects to be removed comprises a line blaster or other game object removal object.

If not, the next step is step S5 in which the game objects which are to be removed are removed from the displayed image.

If so, the next step is step S6 in which it is determined which game objects will be removed by the line blaster. This step is followed by step S5.

It should be appreciated that in other embodiments one or more of the above steps may be omitted. One or more steps may be combined. In some embodiments, the order of one or more steps may be changed.

### Power Pairs

It may be possible to obtain a ‘power pair’, when a user correctly matches two game elements of a first type (game tiles), which both have one or more specific game characteristics, for example both game tiles have a difficulty rating of hard (i.e. three stars). If the user answers the one or more questions correctly, there may be an additional effect.

For example, the special effect may be that any game tiles proximate to the game tiles which have the specific matching game characteristic may be removed. This may be decided on a radial count. For example, a count of one where all tiles touching the game tile with the line blaster characteristic may be removed. For example, a radial count of two, would remove all first game tiles touching the game tile with the line blaster characteristic, and further, all second game tiles touching the first game tiles. It should be appreciated that this may be in any direction, for example, an x direction, y direction, or z direction or any combination thereof, for example, tiles may be removed in a three-dimensional sphere surrounding those with the line blaster characteristic.

### Segmentation

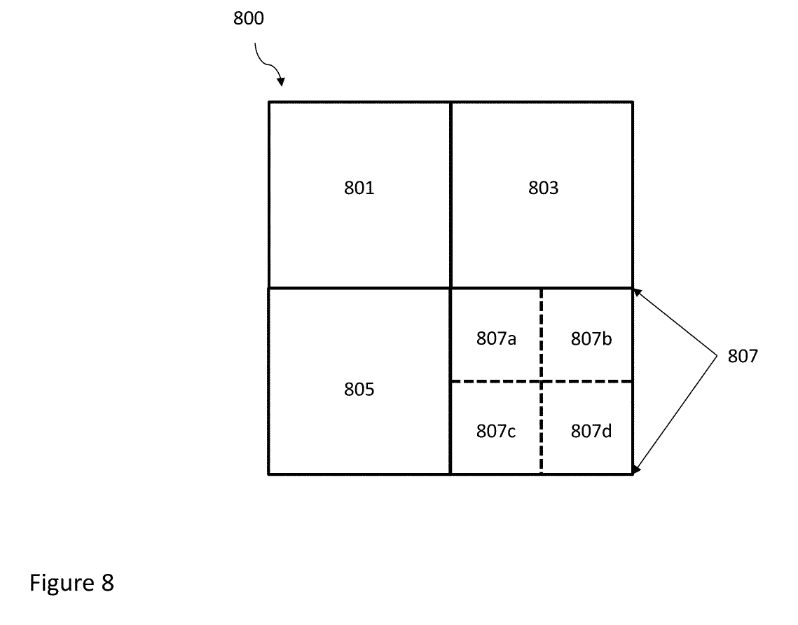

The users may be grouped together in segments. Reference is now made to FIG. 8 which shows an example of user segmentation 800.

Users within a similar groups or sub groups may be matched against each other, or users from across different groups or sub groups may be matched against each other. The user groups and/or sub groups may be stored in a memory 120 and/or externally in a database.

The allocated segment for a user may be determined by a processor 115 and/or external server based upon one or more characteristics.

One such characteristic on whether users may be grouped together may depend on whether users are ‘friends’. Whether users are friends may be determined on whether they share each other's contact details, the contact details may be stores in a memory 120 and/or externally in a database. Whether users are friends may be determined through the application itself, and there may be a way of ‘friending’ other users within the application, alternatively or additionally this may be determined externally by a server. Whether users are friends may also be determined through social media platforms, for example Facebook, Twitter, and the like.

Another such characteristic may for example, be geographical location of a user. The geographical segmentation may be determined based upon location apparatus located within one or more of a user's device, for example a mobile telephone and/or a laptop may have global positioning apparatus, for example GPS. Alternatively or additionally the geographical location may be determined by a user's home and/or other network (e.g. the network currently being used), and/or the country where the device was purchased, and/or by a geotag of a device, and/or by the location of a nearest server, and/or via triangulation of wireless signals from one or more devices owned by a user's.

For example, users in England may be assigned to segment 801, users in the USA may be assigned to segment 803, users in Germany may be assigned to segment 805, and users in France may be assigned to segment 807. Geographical segmentation may be based on recognised national borders, and/or recognised regions within nations. Geographical segmentation may also be based upon towns and/or cities. Furthermore, new geographical regions may be defined using data analytic techniques. Furthermore, the segments, may contain sub-segments of users this sub-segmentation, may be a further geographic segmentation, and/or another type of segmentation, for example ability of the user. For example, users in France 807, may be further segmented into groups 807a, 807b, 807c, and 807d. Where the sub-segmentation is for example, geographical, the sub-segmentation may be, North France 807a, East France 807b, South France 807c, and/or West France 807d. It should be appreciated that the sub-segmentation may be based on other characteristics, for example, user ability, and not restricted to geography.

The geographical segmentation may be used to design one or more questions appropriate to a user's location. For example, if a user is based in England, then the user may be presented with question which are based on a difficulty, and subject matter based on the segmentation of being based in England, whereas if a user is based in the USA, then the user may be presented with question which are based on a difficulty, and subject matter based on the segmentation of being based in the USA. For example, for a sport trivia question, a user based in England may be asked a question pertaining to cricket, whereas a user based in the USA may be asked a question pertaining to baseball.

Another such characteristic on whether users may be grouped together may depend on how good a user is at answering the questions. For example, how many questions they answer correctly and/or incorrectly, and/or how quickly a user provides a correct answer. This may be assessed and determined over a predefined time period, for example, over the period of the most recent month. Alternatively or additionally the users may be ranked on how many questions they answer correctly and/or incorrectly, with the users being grouped dependent on where they are ranked against other users, for example bracketing the rankings. For example, the top 100 users may be segmented into a first group, and the next 100 users into a second group. The determination may be made at a processor 120 and/or externally by a server. The information used may be stored in a memory 120 and/or externally in a database.

The grouping of a user's ability may be a sub group of another segmentation, for example, a sub group for a region.

The users may further be grouped together randomly using a ballot system or the like.

The users may further be grouped together into a tournament to establish the best players in a geographical region, or across the application.

It should be appreciated that each such grouping may be used in isolation or in any combination thereof, and the application is not limited to one or two layers of grouping, with groups having several sub-groups being possible. Furthermore, it should be appreciated that the possible segmentation included here is by way of example only, and the grouping may include other characteristics.

It should be appreciated that one or more of the different features described previously may be provided in any other suitable game. By way of example only, one or more of the above described features may be provided in the context of so-called match 3 games. This is a type of tile-matching game where the player manipulates tiles or game objects according to a matching criterion. By way of example only, the so-called match 3 game may be arranged so as to have a plurality of different layers such as previously described. In some embodiments, any of the blasting functionality previously described may be incorporated in such a game.

A match-three game is a type of casual puzzle game where the player is required to find patterns on a seemingly chaotic board. The player then has to match three or more of the same type of game element on the game board and those matched elements will then disappear. An existing type of match-three game is a so-called “switcher” game. In a switcher game, the player switches place of two adjacent game elements on the game board so that one or both of them create a chain of at least three adjacent game elements of the same type. Those matched game elements will then disappear. The game board is then repopulated with game objects.

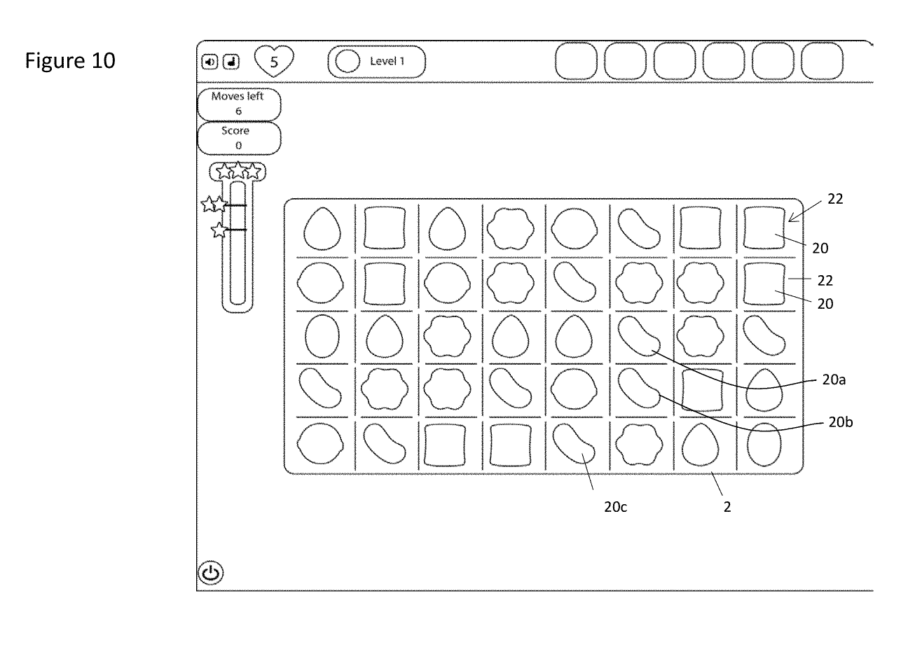

FIG. 10 shows a display of a game board 2 with a plurality of game elements 20. The game elements are each of six different shapes and colours. Of course in other embodiments, there may be more or less than six different game elements. Each game element type may be defined by one or more of particular characteristics, for example a particular shape and colour combination. Each game element is supported by a tile 22.

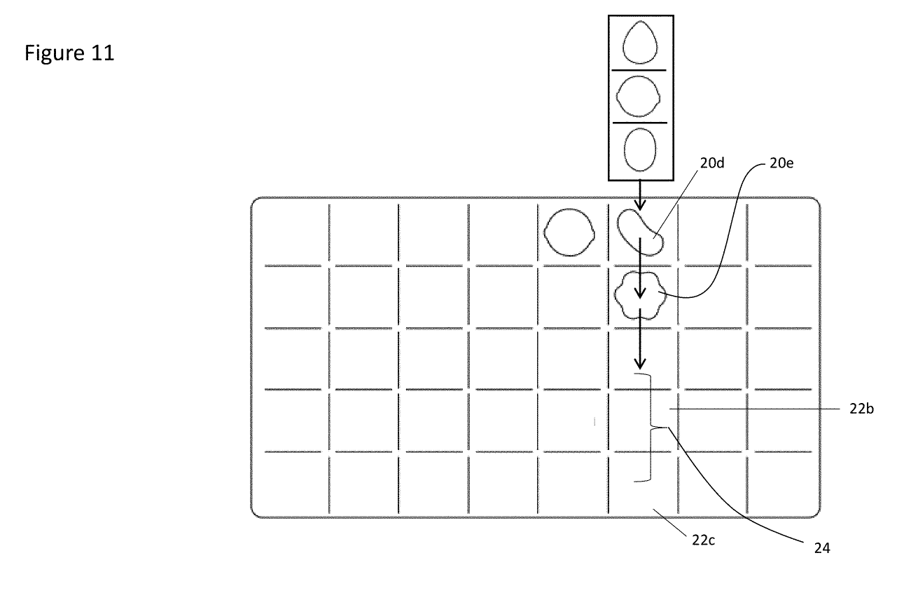

The aim of the game is to swap game elements in the shape of candies with each other to make moves on the game board. To gain points the player has to make moves that create matches of at least three of the same game element or candy. In doing so, the player gains points and the matched game elements are removed. As a result new game elements fall into place from the top of the game board in order to fill any spaces created. Assume in FIG. 10 that game element 20c is moved one place to the right to form a three-line match with game elements 20a and 20b. Turning now to FIG. 11, this has the effect of game elements 20a, 20b and 20c being removed or “disappearing” from the game board, creating a visual effect (animation) on the screen to indicate the disappearance, such as a minimal explosion effect. The two game elements which were directly above game elements 20a will now fall downwards into the spaces created by the removal of game elements 20a, 20b and 20c. Thus, game element 20e will end up at the location 22c, and game element 20d will end up at the location 22b. In addition, three new game elements are provided and fall downwards into the game board to fill the remaining three spaces above location 22b. The new game elements may be generated at random. The user then has a new game board on which to play a subsequent move.

It should be appreciated that the casual game used in some embodiments can be any other suitable game. For example, the game may be so called ‘clicker’ game where the player can click on a group of adjacent game elements of a certain type and those will then be removed. Some clicker games only require two adjacent objects to remove those elements if clicked by the user. Others may require more than two.

Another type of match games are the so called ‘switcher’ games where the player switches the place of two adjacent game elements on the game board so that one or both of them create a chain of at least three adjacent game elements of the same type. Those matched game elements will then disappear. In a typical switcher game the game board will be repopulated with game objects.

Another type of match game are the so called ‘shooter’ games where the player launches for example a ball or bubble on to the game board trying to aim at groups of similar game elements already on the game board. If the launched ball hits or forms a group of more than 3 similar game elements then that group of game elements are removed from the game board.

Some embodiments have been described in the context of specific types of product/software. It should be appreciated that this is by way of example only and other embodiments may be implemented using any other product/software.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

An appropriately adapted computer program code product or products may be used for implementing the embodiments, when loaded on an appropriate data processing apparatus, and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof.

Some embodiments may be provided as a computer program product, included on a computer or machine-readable medium having stored thereon the executable instructions of a computer-readable program that when executed on at least one processor cause a method according to some embodiments to be carried. The terms “computer-readable medium” or “machine-readable medium” as used herein includes any medium that participates in providing instructions to a processor or other components of computer system for execution. Such a medium may take many forms including, but not limited to, storage type media, such as non-volatile media and volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium. Some embodiments may be downloaded or distributed as a computer program product, wherein the computer-readable program instructions may be transmitted from a remote computer such as a server to a user device by way of data signals embodied in a carrier wave or other propagation medium via a network.

The person skilled in the art will realise that the different approaches to implementing the methods and apparatus are not exhaustive, and what is described herein are certain embodiments. It is possible to implement the above in a number of variations without departing from the spirit or scope of the invention.

1. A computer implemented method of managing game objects in a computer implemented game, presented on a display of a computer device having at least one processor, at least one memory and a user interface, the method comprising:
displaying, on the display an arrangement of selectable game objects each having one or more characteristics, information on the arrangement of game objects and the one or more characteristics of the game objects being stored in the at least one memory, the displayed arrangement comprising a first two dimensional layer of selectable game objects arranged overlying at least one further two dimensional layer of selectable game objects;
determining by the at least one processor, a selection of at least one first game object in dependence on a user input received via the user interface;
evaluating by the at least one processor, using the stored information in the at least one memory, responsive to the selection of a least one first game object which one or more of the game objects is to be removed and if any of the game objects which is to be removed is a game removal object comprising a game object removal characteristic;
determining by the at least one processor, when at least one game object to be removed comprises a game removal object, at least one second game object to be removed, in at least one direction extending from the game removal object;
displaying, on the display an updated arrangement of selectable game objects, the game objects determined to be removed having been removed from the updated arrangement.

2. The method as claimed in claim 1, wherein the at least one direction comprises at least one direction in a same layer as the game removal object.

3. The method as claimed in claim 1, wherein the at least one second game object is only be in the same layer as the game removal object.

4. The method as claim 1, wherein the at least one direction comprises at least one direction which extends from a same layer as that of the game removal object to at least one different layer.

5. The method as claimed in claim 1, wherein the at least one second game object is only in one or more different layers to that of the game removal object.

6. The method as claimed in claim 1, wherein the at least one direction comprises at least one direction in a same layer as the game removal object and at least one direction which extends from a same layer as the game removal object to at least one different layer.

7. The method as claimed in claim 1, wherein the at least one direction comprises a plurality of directions such that all second game objects adjacent to the game removal object are removed.

8. The method as claimed in claim 1, wherein the determining by the at least one processor, n second game object to be removed in the or each direction extending from the game removal object, where n is an integer value.

9. The method as claim 1, wherein the evaluating by the at least one processor, comprises determining if two or more of the game objects satisfy a match condition and if so determining that the two or more of the game objects satisfying the match condition are to be removed.

10. The method as claimed in claim 9, wherein two or more game objects satisfying the match condition comprise at least the selected at least one first game object.

11. The method as claimed in claim 9, wherein said user input selecting the at least one first game object causes said match condition to be satisfied.

12. A computer device, comprising at least one processor, at least one memory, a display, a user interface and computer code stored in the memory, and in which the computer code generates computer game graphics for display on the display, and in which the at least one processor is configured to:
cause display, on the display, of an arrangement of selectable game objects each having one or more characteristics, information on the arrangement of game objects and the one or more characteristics of the game objects being stored in the at least one memory, the displayed arrangement comprising a first two dimensional layer of selectable game objects arranged overlying at least one further two dimensional layer of selectable game objects;
determine a selection of at least one first game object in dependence on a user input received via the user interface;
evaluate, using the stored information in the at least one memory, responsive to the selection of a least one first game object which one or more of the game objects is to be removed and if any of the game objects which is to be removed is a game removal object comprising a game object removal characteristic;
determine when at least one game object to be removed comprises a game removal object, at least one second game object to be removed, in at least one direction extending from the game removal object; and
cause display, on the display of an updated arrangement of selectable game objects, the game objects determined to be removed having been removed from the updated arrangement.

13. The computer device as claimed in claim 12, wherein the at least one direction comprises at least one direction in a same layer as the game removal object.

14. The computer device as claimed in claim 12, wherein the at least one second game object is only be in the same layer as the game removal object.

15. The computer device as claimed in claim 12, wherein the at least one direction comprises at least one direction which extends from a same layer as that of the game removal object to at least one different layer.

16. The computer device as claimed in claim 12, wherein the at least one second game object is only be in one or more different layers to that of the game removal object.

17. The computer device as claimed in claim 12, wherein the at least one direction comprises at least one direction in a same layer as that of the game removal object and at least one direction which extends from a same layer as that of the game removal object to at least one different layer.

18. The computer device as claimed in claim 12, wherein the at least one direction comprises a plurality of directions such that all second game objects adjacent to the game removal object are removed.

19. The computer device as claimed in claim 12, wherein the at least one processor is configured to determine, n second game objects to be removed in the or each direction extending from the game removal object, where n is an integer value.

20. The computer device as claimed in claim 12, wherein the at least one processor is configured to determine if two or more of the game objects satisfy a match condition and if so determine that the two or more of the game objects satisfying the match condition are to be removed.

21. The computer device as claimed in claim 20, wherein two or more game objects satisfying the match condition comprise at least the selected at least one first game object.

22. The computer device as claimed in claim 20, wherein said user input selecting the at least one first game object causes said match condition to be satisfied.

23. A non-transitory computer readable storage device storing instructions that, when executed by at least one processor, causes the at least one processor to perform the following steps:
cause display, on a display, of an arrangement of selectable game objects each having one or more characteristics, the displayed arrangement comprising a first two dimensional layer of selectable game objects arranged overlying at least one further two dimensional layer of selectable game objects;
determine a selection of at least one first game object in dependence on a user input received via a user interface;
evaluate responsive to the selection of a least one first game object which one or more of the game objects is to be removed and if any of the game objects which is to be removed is a game removal object comprising a game object removal characteristic; and
determine, when at least one game object to be removed comprises a game removal object, at least one second game object to be removed in at least one direction extending from the game removal object; and cause displaying, on the display, of an updated arrangement of selectable game objects, the game objects determined to be removed having been removed from the updated arrangement.
